(19) United States
(12) Patent Application Publication
(10) Pub. No.: US 2026/0167296 A1
(43) Pub. Date: Jun. 18, 2026

(54) Method for Operating a Pedal-Driven Vehicle and a Pedal-Driven Vehicle

(71) Applicant: Robert Bosch GmbH, Stuttgart (DE)

(72) Inventors: Daniel Gronbach, Stuttgart (DE); Joseph Reck, Weil Im Schoenbuch (DE); Juergen Stegmaier, Wannweil (DE); Marcus Boege, Rottenburg Am Neckar (DE); Matthias Weinmann, Balingen (DE)

(21) Appl. No.: 19/414,801

(22) Filed: Dec. 10, 2025

(30) Foreign Application Priority Data
Dec. 13, 2024 (DE) 10 2024 211 919.9

(51) Int. Cl. B62M 6/45

(52) U.S. Cl. CPC B62M 6/45

(57) ABSTRACT

A method for operating a pedal-driven vehicle is disclosed. The pedal-driven vehicle includes a drive for providing a drive torque for propelling the pedal-driven vehicle, a control unit, and a gearshift for providing a variable transmission ratio. The method includes (i) providing shift information for a planned shift operation comprising a primary target drive torque, (ii) providing a secondary target drive torque, (iii) selecting a target drive torque from the primary target drive torque and the secondary target drive torque, and (iv) controlling the drive such that the drive torque provided by the drive corresponds to the selected target drive torque.

This application claims priority under 35 U.S.C. § 119 to patent application no. DE 10 2024 211 919.9, filed on Dec. 13, 2024 in Germany, the disclosure of which is incorporated herein by reference in its entirety.

### BACKGROUND

Pedal-driven vehicles, in particular bicycles or electric bicycles or pedelecs, are typically equipped with a gearshift. The gearshift allows a transmission ratio in a drive train of the vehicle to be adjusted based on the current travel situation. As a result, the propulsion of the pedal-driven vehicle may be made more comfortable for a rider while traveling uphill, downhill, or on flat terrain.

Furthermore, pedal-driven vehicles, in particular bicycles or electric bicycles or pedelecs, can be equipped with a drive that is used to assist the rider in propelling the pedal-driven vehicle.

It is generally known that performing shift operations under load can promote mechanical wear on the gearshift or even lead to failure of individual components. This may be countered by a temporary reduction of the drive torque provided by the drive during the period of the shift operation.

In the context of the disclosure, the disadvantage in this respect has become clear that shift operations under reduced drive torque can nevertheless be perceived as unpleasant by a rider of the pedal-driven vehicle. Furthermore, it has also been shown that travel situations can occur in which a reduction in driving torque on the part of the rider can be perceived as annoying or even promote a risk to the rider.

### SUMMARY

The present disclosure relates to a method for operating a pedal-driven vehicle, a pedal-driven vehicle, a computer program product, a computer-readable medium, and a data carrier signal. Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable storage medium according to the disclosure and/or in connection with the data carrier signal according to the disclosure, and vice versa, so that there is or can always be mutual reference with regard to the disclosure of the individual aspects of the disclosure.

The disclosure presented is particularly intended to provide improved operation of an, in particular automatic or semi-automatic, gearshift of a pedal-driven vehicle with respect to improved comfort of use and/or increased safety of the pedal-driven vehicle.

According to a first aspect, the present disclosure relates to a method for operating a pedal-driven vehicle, comprising a drive for providing drive torque for propelling the pedal-driven vehicle, a control unit, a gearshift for providing a variable transmission ratio, the method comprising:
providing shift information for a planned shift operation comprising a primary target drive torque, in particular by the gearshift,
providing a secondary target drive torque, in particular by the control unit,
selecting a target drive torque from the primary target drive torque and the secondary target drive torque, in particular by the control unit, and
controlling the drive such that the drive torque provided by the drive corresponds to the selected target drive torque, in particular by way of the control unit.

It may preferably be provided that the stated method steps are carried out in the specified order. Additionally or alternatively, it is contemplated that at least individual method steps will be performed recurrently, in particular in a loop and/or, at least in part, simultaneously. Additionally or alternatively, the method can be configured as a computer-implemented method.

In other words, a method of operating a pedal-driven vehicle is proposed, wherein the pedal-driven vehicle comprises a drive for providing a drive torque for propelling the pedal-driven vehicle, at least one control unit and at least one gearshift. The gearshift is preferably used to provide a variable transmission ratio, particularly in a drive train of the pedal-driven vehicle.

It is further provided that, in particular by way of the gearshift, shift information is provided for a planned shift operation. In particular, the shift information may be generated by the gearshift and transmitted to or provided to the control unit. The shift information includes a primary target drive torque.

In the present case, the primary target drive torque is to be understood as a target drive torque provided by the gearshift to which the drive torque provided by the drive is to be decreased during the performance of the planned shift operation. In particular, the primary target drive torque may be selected such that impairment of the service life of the gearshift or mechanical damage to the gearshift other than normal wear during the shift operation is avoided or substantially avoided.

In other words, the primary target drive torque may be considered a predetermined target drive torque, which is in particular characteristic of a mechanical load limit of the gearshift. For example, the primary target drive torque may be predetermined by a manufacturer of the gearshift. It may be provided as a specification by the manufacturer of the gearshift to operate the gearshift. For example, the predetermined target drive torque may be optimized with respect to the service life of the respective gearshift.

Furthermore, it is provided that, in particular by the control unit, a secondary target drive torque is provided. In the present case, the secondary target drive torque is to be understood as a target drive torque provided, in particular by the control unit, to which the drive torque provided by the drive is to be decreased during the performance of the planned shift operation. In particular, the secondary target drive torque may be selected such that during execution of the planned shift operation, as high a ride comfort as possible for a rider of the pedal-driven vehicle is maintained. Maintaining ride comfort may be realized, for example, by maintaining a maximum volume and/or limiting the chain acceleration occurring during a shift operation.

In other words, the secondary target drive torque may be considered to be an instantaneous target drive torque which is characteristic of compliance with at least one comfort requirement and at least one assistance requirement. The instantaneous target drive torque is in particular optimized for a comfortable ride and/or assistance appropriate for the travel situation. In particular, the shift operation and/or drive assistance is intended to be comfortable for the rider during the shift operation so that the rider experiences a comfortable shift experience. A safe shift experience may also be considered a comfortable shift experience. The instantaneous target drive torque is in particular provided as a function of at least one gear change parameter and/or at least one travel parameter. It takes into account the current and/or instantaneous travel situation and/or gear change situation with regard to a comfort specification and/or an assistance specification such that the travel situation is optimized for a rider.

Particularly during shift operations in which a chain, in particular on the pinion cassette, is shifted from a large to a small pinion, i.e., upshifted or the transmission ratio is increased, the chain temporarily loses traction with the pinions. In this case, a torque applied to the drive train provided by the rider and/or the drive will result in a significant acceleration of the chain. If an engagement between the chain and the pinion is subsequently made again, the chain is abruptly decelerated, which is perceived as jerky by the rider as part of a shift operation. This effect may be mitigated by reducing the drive torque provided by the drive, and thus the shift operation may be more comfortable for a rider.

According to the disclosure, it is further provided that, in particular by the control unit, a target drive torque is selected from the primary target drive torque and the secondary target drive torque, and the drive, in particular by the control unit, is controlled such that the drive torque provided by the drive corresponds to the selected target drive torque.

In the context of the present disclosure, it has been recognized that the specifications transmitted by the gearshift to reduce a drive torque during a shift operation are not useful in all travel situations or partially not sufficient to make the shift operation comfortable for a rider of the pedal-driven vehicle. According to the disclosure, therefore, a secondary target drive torque is determined or provided in addition to a primary drive torque provided on the gearshift side. In this way, other influencing factors such as gear change parameters and/or travel parameters are taken into account to not only prevent mechanical damage to the gearshift during the planned shift operation, but also to maintain as high a usage comfort as possible for a rider of the pedal-driven vehicle, or to prevent a risk to the rider due to excessive reduction of the drive torque.

Determining or providing the secondary target drive torque may in particular be performed using a torque model, wherein the torque model depicts a functional relationship between at least one input parameter and a secondary target drive torque as output parameter. At least one input parameter may preferably be configured as a gear change parameter and/or a travel parameter. In particular, a multi-dimensional dependency can be provided in this regard, i.e., more than one input parameter is used to determine the output parameter. The torque model may preferably be stored on a data memory of the pedal-driven vehicle, in particular the control unit.

It may preferably be provided in relation to the present disclosure that the shift information comprises at least one gear change parameter. Preferably, it is contemplated that the secondary target drive torque is provided as a function of at least one gear change parameter.

In the present case, a gear change parameter is to be understood as a parameter that is characteristic of the planned shift operation. For example, at least one shift parameter may be configured as one of the following:
a shift direction indication,
a gear difference indication,
an actual gear indication,
a target gear indication,
a shift timing indication.

In the present case, a shift direction indication is to be understood as an indication of whether to shift up to increase the transmission ratio, i.e. to shift to a higher gear, or to reduce the transmission ratio down, i.e. to shift to a lower gear. In particular, it may be provided that a lower secondary target drive torque is provided with respect to a shift direction indication during the upshift than during the downshift. The reason for this is that when shifting up, the chain briefly loses contact with the pinion cassette and is accelerated accordingly when there is high torque in the drive train. During the downshift, the chain, in particular on the pinion cassette, is instead shifted from a smaller to a larger pinion. In this case, the transmission of force between the chain and the pinion remains substantially continuous. Accordingly, during a shift operation, higher torques can be transmitted in the drive train without mechanical damage to the chain or pinions and without compromising comfort.

It can also be provided that at least one gear change parameter is configured as a gear difference indication. In the present case, a gear difference indication is to be understood as an indication of how many gears in the context of the planned shift operation, starting from the current gear or actual gear, are to be upshifted or downshifted. In this regard, it can in particular be provided that a lower or decreasing secondary target drive torque is provided as the gear difference increases. This makes gear changes, especially when shifting down several gears at once, more comfortable for the driver.

Further gear change parameters can be, for example, an actual gear indication, i.e. an indication of which gear is currently engaged and/or a target gear indication, i.e. an indication of which gear is to be engaged. The shift direction or a gear difference can be derived from the actual gear indication and the target gear indication and a secondary target drive torque can be provided accordingly. Additionally or alternatively, at least one gear change parameter can be configured as a shift timing, i.e., a time indication for when the planned shift operation is to be performed.

With respect to the present disclosure, it may be provided that the primary target drive torque is characteristic of a mechanical load limit of the gearshift, in particular during the planned shift operation. This means that if the primary target drive torque is exceeded, in particular during the execution of the planned shift operation, mechanical damage or comparatively high wear on the gearshift is to be expected and thus losses in terms of the service life are to be expected.

Additionally or alternatively, it may be provided that the secondary target drive torque is characteristic of maintaining at least one comfort requirement and at least one assistance requirement. In other words, it may be provided that the secondary drive torque be selected such that at least one comfort requirement and/or at least one assistance requirement is safely met during the planned shift operation.

A comfort requirement can be, for example, a maximum loudness and/or a maximum acceleration of the chain that occurs during the planned shift operation. In the present case, an assistance specification is to be understood as a minimum level of assistance to be maintained by the drive during a specific travel situation. Thus, especially in the case of steep trail passes or ascents, it may be uncomfortable for the rider if the drive-side assistance is reduced too much. In extreme cases, excessive reduction of assistance can even cause a fall, thereby endangering the safety of the rider.

It should therefore be noted in particular that the primary and secondary target drive torques address different target values, namely, on the one hand, minimal or acceptable mechanical wear on the gearshift through the primary target drive torque and, on the other hand, the highest possible travel comfort and sufficient safety for the rider by the secondary target drive torque.

The comfort requirements and/or the assistance requirements or the secondary target drive torques associated therewith can be determined vehicle-specifically and stored for the operation of the vehicle in a data store, in particular of the control unit, e.g. in the form of a torque model.

It may further be provided with respect to the present disclosure that the primary target drive torque and/or the secondary target drive torque are specific to a shift operation. In other words, it may be provided that the primary target drive torque and/or the secondary target drive torque be determined individually for each shift operation. Thus, the respective torques may also be configured differently during different shift operations.

Advantageously, with respect to the present disclosure, it may further be provided that selecting the target drive torque comprises:
selecting the minimum drive torque from the primary target drive torque, particularly the upper and/or lower primary drive torque, and the secondary target drive torque as the target drive torque, particularly by the control unit.

In other words, the respective smaller drive torque is selected from the primary and secondary target drive torque and used to control the drive. This ensures that for the planned shift operation, both the mechanical load limit of the shift is complied with and a high level of comfort and a high level of safety for the rider during the shift operation is ensured.

Additionally or alternatively, it may further be provided in relation to the present disclosure that the method further comprises:
detecting at least one travel parameter, in particular by the control unit and/or at least one detection unit,
providing the secondary target drive torque as an additional function of at least one travel parameter, in particular by the control unit, and in particular
selecting the target drive torque as a function of at least one travel parameter, in particular by the control unit.

In the present case, a travel parameter is to be understood as a parameter that characterizes a, in particular current, travel situation of the pedal-driven vehicle. In particular, at least one travel parameter may be configured as:
a slope of the pedal-driven vehicle, in particular relative to a horizontal,
a speed of the pedal-driven vehicle,
an acceleration of the pedal-driven vehicle,
a rider pedaling frequency,
a rider torque,

A temporal rate of change of the above-mentioned parameters can each form a travel parameter.

Detecting the slope of the pedal-driven vehicle may preferably be realized by detecting a pitch angle. In particular, the pitch angle is to be distinguished from a roll angle, which changes when the rider leans into a curve, for example.

Based on the stated travel parameters, it is possible to detect various travel situations such as a ride uphill or downhill, an acceleration or deceleration of the pedal-driven vehicle, and/or a ride at high and low speed. Furthermore, by using time change rates, a transition from a travel situation to a different driving situation may be reliably detected. Depending on the current travel situation, this allows a suitable secondary target drive torque to be provided.

Thus, it may be in particular provided that if the slope, particularly the pitch angle, of the pedal-driven vehicle reaches or exceeds a slope limit value, in particular a pitch limit value, a higher drive torque than the secondary target drive torque is provided than if the slope reaches or falls below the slope limit value. By evaluating the slope, a ride uphill or downhill can be reliably detected. In particular when traveling uphill, the driving torque should not be reduced or not significantly reduced to avoid a risk to the rider. For example, high speeds, accelerations, rates of change of pedaling frequency, or a high rider torque also indicate a dynamic travel situation in which the rider's assistance should be maintained in the best possible way.

In particular, it may be provided that selecting the target drive torque comprises:
selecting the maximum drive torque from the primary target drive torque, particularly the lower and/or upper primary drive torque, and the secondary target drive torque as the target drive torque when at least one travel parameter reaches or exceeds a predetermined limit value, and
selecting the minimum drive torque from the primary target drive torque, particularly the lower and/or upper primary drive torque, and the secondary target drive torque as the target drive torque when at least one travel parameter, in particular all travel parameters, reaches or falls below a predetermined limit value.
   It may be provided that a specific limit value is provided for each travel parameter. Additionally or alternatively, it may be provided that the comparison of a travel parameter with the respective limit value in relation to the amount of the travel parameter will be performed to equally account for deviations in different directions. For deviations in different directions (for example, acceleration and deceleration), individual limit values are specified.

Furthermore, it may be advantageously provided that the shift information comprises a lower primary drive torque and an upper primary drive torque, wherein the target torque is always selected such that the upper primary drive torque is not exceeded. In other words, it may be provided that the upper primary drive torque will form a limit that will never be exceeded when selecting the target drive torque from the primary and secondary drive torque. If, for example, the maximum of primary and secondary drive torque were to be selected and the secondary drive torque were greater than the primary upper drive torque, the primary upper drive torque would still be selected as the target drive torque. In particular, it may be provided that the upper primary target drive torque is greater than the lower primary drive torque.

The upper primary target drive torque is to be understood as a drive torque that may not be exceeded, since otherwise mechanical damage or failure of the gearshift is to be expected. The lower primary target drive torque is to be understood as a drive torque, which should not or should not be regularly exceeded in order to ensure as long a service life of the gearshift as possible, but which does not directly lead to failure. The shift-side specified recommendation on the driving torque can thereby be specified further. In particular, in exceptional situations, the torque may be left above the recommendation provided on the shift-side without affecting the function of the gearshift or without directly damaging the gearshift.

According to a second aspect, the present disclosure relates to a pedal-driven vehicle comprising a drive for providing drive torque for propelling the pedal-driven vehicle, a control unit, and a gear shift for providing a variable transmission ratio. The pedal-driven vehicle is preferably configured to be operated according to a method according to the disclosure, in particular according to a method according to the first aspect of the disclosure. Preferably, the pedal-driven vehicle may be configured as a bicycle, preferably an electric cycle or pedelec. With respect to a pedal-driven vehicle, the same advantages result as described in relation to a method according to the disclosure. Preferably, the pedal-driven vehicle may comprise two wheels, in particular a front wheel and a rear wheel.

The drive may preferably be configured as an electric motor and/or positioned in a center motor assembly on the pedal-driven vehicle.

In particular, the gear shift may be provided to provide a variable transmission ratio, in particular in a drive train of the pedal-driven vehicle. The transmission ratio may be in particular characteristic of the number of revolutions of a drive wheel of the pedal-driven vehicle per revolution of a crank mechanism of the pedal-driven vehicle. In this respect, a high transmission ratio or high gear characterizes a comparatively high number of revolutions of the drive gear per revolution of the crank train. In contrast, a low transmission ratio or low gear characterizes a comparatively low number of revolutions of the drive gear per revolution of the crank train. In particular, a driver of the pedal-driven vehicle may introduce a driver torque to propel the vehicle, in particular via crank-drive pedals, via the crank train.

In the present case, the gearshift may be configured as a derailleur gear system or a hub gear. Additionally or alternatively, it may be provided that the gearshift is configured as an automatic or at least partially automated gearshift. Particularly preferably, the gearshift may be configured to initiate or perform automated shift operations based on one or more travel parameters, in particular as a function of the rider pedaling frequency and/or speed of the pedal-driven vehicle.

A travel parameter may be, for example, a slope, speed or acceleration of the pedal-driven vehicle, a pedaling frequency of a rider of the pedal-driven vehicle, a rider torque introduced by a rider of the pedal-driven vehicle to propel the vehicle, or a power provided by a rider of the pedal-driven vehicle to propel the vehicle.

The gearshift may preferably comprise at least one user interface, in particular a shift lever, via which a rider can manually trigger shift operations.

The shift information may be provided by the gearshift when an impending shift operation has been detected. This may be done by rider actuation of a user interface or based on changing at least one travel parameter.

The disclosure may provide for at least one detection unit to be included. In particular, at least one detection unit may comprise at least one sensor element.

Preferably, the detection unit may comprise at least one accelerometer for detecting an acceleration of the pedal-driven vehicle. For example, at least one accelerometer may be configured to measure a speed of the pedal-driven vehicle, for example, via the rotational speed of a wheel of the pedal-driven vehicle and the outer circumference of the wheel. The acceleration may be determined by temporal differentiation of the speed as a change in the speed per unit of time. Accordingly, an accelerometer and a speed sensor may be mapped by a single sensor. Also, at least one accelerometer may be configured as an inertial measurement unit (IMU).

Additionally or alternatively, the detection unit may comprise at least one pedaling frequency sensor for detecting a pedaling frequency of a rider of the pedal-driven vehicle. The pedaling frequency is intended to be understood as the frequency at which the rider rotates a crank mechanism of the pedal-driven vehicle, in particular via pedals. At least one pedaling frequency sensor may be configured as a speed sensor. In particular, the speed sensor may be configured to determine a speed of a crank mechanism of the pedal-driven vehicle to determine the rider's pedaling frequency. The rate of change of pedaling frequency may be determined by temporal differentiation of the pedaling frequency as a change of pedaling frequency per unit of time.

Additionally or alternatively, the detection unit may comprise at least one torque sensor for detecting a rider torque, in particular on the crank mechanism. The rider torque is to be understood as a torque for propelling the pedal-driven vehicle, which is introduced by a rider, in particular via a crank mechanism. The rate of change of the rider torque may be determined by time differentiation of the rider torque as a change in the pedaling frequency per unit of time.

Additionally or alternatively, the detection unit may comprise at least one speed sensor for detecting a speed of the pedal-driven vehicle. For example, at least one speed sensor may be configured to measure a speed of the pedal-driven vehicle, for example, via the rotational speed of a wheel of the pedal-driven vehicle and the outer circumference of the wheel.

Additionally or alternatively, the detection unit may comprise at least one slope sensor for detecting a slope of the pedal-driven vehicle. In particular, at least one slope sensor may be configured as an inertial measurement unit (IMU).

It may be provided in the context of the disclosure that at least one gearshift and/or control unit and/or detection unit comprises a data processing device. The data processing device may comprise at least one processor and/or working memory and/or non-volatile data store.

At least one control unit may be brought into communication and/or signal communication with a gear shift and/or detection unit and/or a drive, at least temporarily. Thus, data and/or control or regulating signals between the units may be exchanged.

At least one control unit and at least one detection unit may be configured as a common unit.

According to a third aspect, the present disclosure relates to a computer program product, comprising instructions which cause a pedal-driven vehicle in accordance with the second aspect to execute a method in accordance with the first aspect. With respect to a computer program product according to the disclosure, the same advantages result in that they have already been described in relation to a method according to the disclosure and/or a pedal-driven vehicle according to the disclosure.

According to a fourth aspect, the present disclosure relates to a computer-readable medium, in particular a storage medium, wherein a computer program product according to the third aspect of the disclosure is stored on the computer-readable medium. With respect to a computer-readable medium according to the disclosure, the same advantages result in that they have already been described in relation to a method according to the disclosure and/or a pedal-driven vehicle according to the disclosure and/or a computer program product according to the disclosure.

According to a fifth aspect, the present disclosure relates to a data carrier signal transmitting a computer program product according to the third aspect of the present disclosure. With respect to a data carrier signal according to the disclosure, the same advantages result in that they have already been described in relation to a method according to the disclosure and/or a pedal-driven vehicle according to the disclosure and/or a computer program product according to the disclosure and/or a computer-readable medium according to the disclosure.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 is a view of a method, and

FIG. 2 is a view of a pedal-driven vehicle.

### DETAILED DESCRIPTION

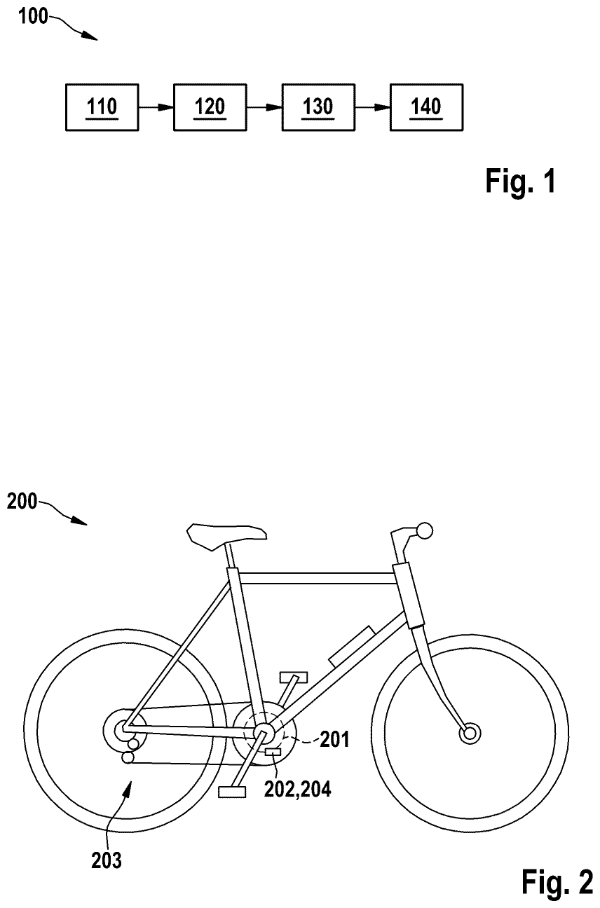

FIG. 1 illustrates a schematic view of a method 100 for operating a pedal-driven vehicle 200, comprising a drive 201 for providing a drive torque for propelling the pedal-driven vehicle 200, a control unit 202, a gear shift 203 for providing a variable transmission ratio, the method 100 comprising:
providing 110 shift information on a planned shift operation comprising a primary target drive torque and at least one gear change parameter,
providing 120 a secondary target drive torque as a function of at least one gear change parameter,
selecting 130 a target drive torque from the primary target drive torque and the secondary target drive torque, and
controlling 140 the drive 201 such that the drive torque provided by the drive 201 corresponds to the selected target drive torque, in particular by way of the control unit 202.

Furthermore, FIG. 2 illustrates a schematic view of a pedal-driven vehicle 200, comprising a drive 201 for providing a drive torque for propelling the pedal-driven vehicle 200, a control unit 202, and a gear shift 203 for providing a variable transmission ratio. In particular, the pedal-driven vehicle 200 is configured to operate according to a method 100 shown in FIG. 1.

Furthermore, the pedal-driven vehicle 200 includes at least one detection unit 204 to detect at least one travel parameter. In the present case, the detection unit 204 and the control unit 202 are configured as a common unit.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating a pedal-driven vehicle that includes a drive for providing a drive torque for propelling the pedal-driven vehicle, a control unit, and a gearshift for providing a variable transmission ratio, the method comprising:
providing shift information for a planned shift operation comprising a primary target drive torque;
providing a secondary target drive torque;
selecting a target drive torque from the primary target drive torque and the secondary target drive torque; and
controlling the drive such that the drive torque provided by the drive corresponds to the selected target drive torque by way of the control unit.

2. The method according to claim 1, wherein the primary target drive torque is a predetermined target drive torque, which is characteristic of a mechanical load limit of the gearshift.

3. The method according to claim 1, wherein the secondary target drive torque is an instantaneous target drive torque, which is characteristic of a compliance with at least one of a comfort specification and at least one assistance specification.

4. The method according to claim 3, wherein the instantaneous target drive torque is provided as a function of at least one gear change parameter and/or at least one travel parameter.

5. The method according to claim 1, further comprising:
providing at least one gear change parameter, and
providing the secondary target drive torque as a function of the at least one gear change parameter.

6. The method according to claim 5, wherein the at least one gear change parameter is configured as one of the following:
a shift direction indication,
a gear difference indication,
an actual gear indication,
a target gear indication, and
a shift timing.

7. The method according to claim 1, wherein the selecting step comprises:
selecting the minimum drive torque from the primary target drive torque and the secondary target drive torque as the target drive torque.

8. The method according to claim 4, further comprising:
detecting the at least one travel parameter by at least one detection unit, and
providing the secondary target drive torque as a function of the at least one travel parameter.

9. The method according to claim 8, wherein the at least one travel parameter is configured as one of the following:
a slope of the pedal-driven vehicle,
a speed of the pedal-driven vehicle,
an acceleration of the pedal-driven vehicle,
a rider pedaling frequency, and
a rider torque.

10. The method according to claim 4, wherein the selecting step comprises:
selecting the maximum drive torque from the primary target drive torque and the secondary target drive torque as the target drive torque when the at least one travel parameter reaches or exceeds a predetermined limit value, and
selecting the minimum drive torque from the primary target drive torque and the secondary target drive torque as the target drive torque when the at least one travel parameter reaches or falls below a predetermined limit value.

11. The method according to claim 1, wherein:
the shift information comprises a lower primary drive torque and an upper primary drive torque, and
the target torque is always selected such that the upper primary drive torque is not exceeded.

12. A pedal-driven vehicle, comprising:
a drive configured to provide a drive torque for propelling the pedal-driven vehicle;
a control unit; and
a shift gear configured to provide a variable transmission ratio,
wherein the pedal-driven vehicle is configured to operate according to the method of claim 1.

13. A computer program product comprising instructions that cause a pedal-driven vehicle to perform the method according to claim 1.

14. A computer-readable medium on which the computer program product according to claim 1 is stored.

15. A data carrier signal transmitting the computer program product according to claim 13.

16. The method according to claim 4, wherein the selecting step comprises:
selecting the maximum drive torque from the primary target drive torque and the secondary target drive torque as the target drive torque when the at least one travel parameter reaches or exceeds a predetermined limit value, and
selecting the minimum drive torque from the primary target drive torque and the secondary target drive torque as the target drive torque when all the travel parameters reach or fall below a predetermined limit value.
